(19) United States
(12) Patent Application Publication
(10) Pub. No.: US 2026/0113353 A1
(43) Pub. Date: Apr. 23, 2026

(54) METHOD AND SYSTEM BASED ON CONTRASTIVE LEARNING FOR ASSISTING RECOMMENDATION SYSTEM TO DEFEND AGAINST SHILLING ATTACKS

(71) Applicant: Jinan University, Guangzhou (CN)

(72) Inventors: Feiran HUANG, Guangzhou (CN); Zhibo ZHOU, Guangzhou (CN); Zhi LI, Guangzhou (CN); Guoliang CHEN, Guangzhou (CN); Shaojun XIE, Guangzhou (CN); Siyi DING, Guangzhou (CN)

(73) Assignee: Jinan University, Guangzhou (CN)

(21) Appl. No.: 19/363,680

(22) Filed: Oct. 21, 2025

(30) Foreign Application Priority Data
Oct. 22, 2024 (CN) 2024114766503

(51) Int. Cl. H04L 9/40; G06N 3/042; G06N 3/08

(52) U.S. Cl. CPC H04L 63/1466; G06N 3/042; G06N 3/08

(57) ABSTRACT

The present disclosure discloses a method and system based on contrastive learning for assisting a recommendation system to defend against shilling attacks, and belongs to the field of recommendation system security. The method includes: establishing an interaction matrix using interaction data; achieving data augmentation by using the target user's neighbor nodes as positive samples and a non-target user's neighbor nodes as negative samples; establishing a contrastive learning model, a user detection model, and a recommendation model resistant to shilling attacks, performing joint training on the three models, computing user-item interaction scores after training, and taking the top-20 scoring interacted items to form a recommendation list for the user. Based on a recommendation system, the present disclosure combines contrastive learning and a multi-layer perceptron to detect fake users and utilizes confidence values as weights to implement a recommendation system method resistant to shilling attacks.

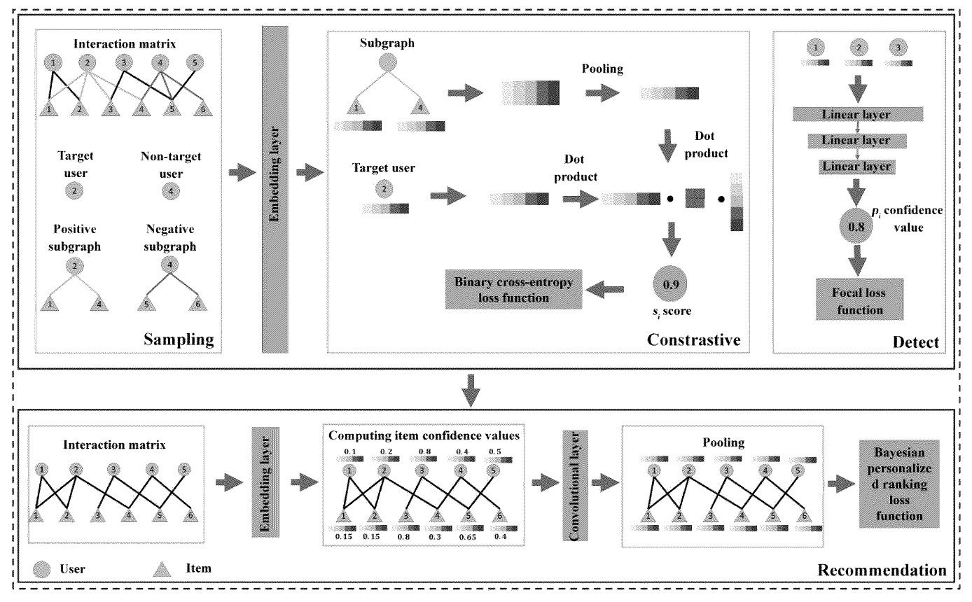

### CROSS-REFERENCE TO RELATED APPLICATIONS

The application claims priority to Chinese patent application No. 2024114766503, filed on Oct. 22, 2024, the entire contents of which are incorporated herein by reference.

### TECHNICAL FIELD

The present disclosure relates to the technical field of recommendation system security, and in particular to a method and system based on contrastive learning for assisting a recommendation system to defend against shilling attacks.

### BACKGROUND

With the rapid development of Internet technology, the benefits brought by the Internet have made people's interaction with the Internet increasingly frequent. Meanwhile, information on the Internet is also growing, allowing people to easily obtain massive amounts of information. However, due to limited human information processing capabilities, it has become increasingly difficult to filter useful information from large volumes of data. To solve the problem of information overload, recommendation systems emerged, aiming to help users obtain information they may be interested in more quickly, efficiently and personally. Recommendation systems have developed rapidly and have been applied in many fields, such as shopping, food delivery, news, and music, providing customers with more comfortable and accurate services while also attracting huge user traffic for merchants. However, with the rapid development of recommendation systems, security issues of recommendation systems have become increasingly prominent. Among them, shilling attacks are an important research direction in the security of recommendation systems. Attackers, for certain purposes, generate fake user interaction records and inject them into the dataset, thereby manipulating the recommendation list of the recommendation system. This brings benefits to the attackers but reduces the recommendation accuracy and personalization of the recommendation system, causing huge losses to the recommendation platform.

Collaborative filtering technology is a widely used technology in recommendation systems. Collaborative filtering technology analyzes user preferences based on user historical behavior data and specifically recommends items to target users according to the interest preferences of similar users or the interest preferences of similar items. Recently, in collaborative filtering technology, graph neural network recommendation systems have been extensively applied because they aggregate high-order neighbor information, making recommendations more accurate and efficient. However, at the same time, due to the aggregation of high-order neighbor information, the recommendation systems are more affected by shilling attacks, resulting in greater losses. Current methods used for defense against shilling attacks in recommendation systems can alleviate the impact of shilling attacks to a certain extent, but the accuracy of detecting fake users is low, resulting in weak defense capability against shilling attacks and poor recommendation effectiveness. Using traditional machine learning methods as detectors performs poorly with large data volumes due to poor generalization ability. In scenarios with a large number of fake users, the method of using a graph neural network model to generate feature vectors and then performing detection through a neural network exhibits low detection accuracy and in turn poor recommendation effectiveness due to the cross-propagation of information between fake users and normal users.

### SUMMARY

In order to address the above issues, the purpose of the present disclosure is to provide a technology based on contrastive learning for improving defense against shilling attacks in a recommendation system. The technology aims to overcome the difficulties of low accuracy in detecting fake users in different scenarios and poor recommendation effectiveness under shilling attacks, and also to improve the defense capability of the recommendation system against shilling attacks.

To meet the above technical purpose, the present application provides a method based on contrastive learning for assisting a recommendation system to defend against shilling attacks, the method including the following steps:
based on an open-source online recommendation system dataset containing fake users, establishing a user-item interaction matrix, and generating user feature vectors by passing user and item nodes through an embedding layer;
based on the user-item interaction matrix, performing data augmentation by sampling positive and negative samples, resulting in augmented data;
based on a weighted dot product and binary cross-entropy, establishing a contrastive learning model by training with the augmented data;
based on a three-layer neural network and a focal loss function, establishing a user detection model by performing model training with the user feature vectors, thereby obtaining user confidence values;
based on a weighted three-layer graph neural network and a Bayesian personalized ranking loss function, obtaining positive and negative sample pair data by using the user-item interaction matrix, and using the data together with the user confidence values as input data for model training, thereby establishing a recommendation model resistant to shilling attacks; and
performing joint training on the contrastive learning model, the user detection model, and the recommendation model resistant to shilling attacks, performing dot product operations between each user's feature vector and all items' feature vectors to obtain scores, and generating a recommendation list for the user.

Preferably, in the process of performing data augmentation, each user is taken as a target user, and a positive sample subgraph feature vector set is obtained by performing proportional sampling from the set of items with which the target user has interacted; an arbitrary non-target user node is selected, and a negative sample subgraph feature vector set is obtained by performing proportional sampling from the set of items with which the non-target user has interacted; the augmented data is generated based on the positive sample subgraph feature vector set and the negative sample subgraph feature vector set.

Preferably, in the process of establishing the contrastive learning model, the positive and negative sample subgraph feature vector sets are stacked and undergo an average pooling operation separately, to obtain the subgraph feature vectors;
the subgraph feature vectors then respectively undergo a weighted dot product operation with the target user's feature vector to obtain scores; and
a binary cross-entropy (BCE) loss function is used for learning and training to establish the contrastive learning model.

Preferably, in the process of establishing the user detection model, ReLu is applied to the first two layers of the three-layer neural network, and sigmoid is applied to the last layer.

Preferably, in the process of sampling negative sample pairs, Bayesian positive and negative sample pair sampling is performed on the user-item interaction matrix.

Preferably, in the process of establishing a recommendation model resistant to shilling attacks, the confidence values are used as weights in convolution operations, wherein the confidence values include user confidence values and item confidence values; the item confidence values are obtained by performing graph convolution operations on the interaction matrix using the user confidence values.

Preferably, in the process of generating the recommendation list, the top-20 scoring ones from the items with which the user has interacted are taken as the user's recommendation list.

The present disclosure discloses a system based on contrastive learning for assisting a recommendation system to defend against shilling attacks. The system is used to implement the above-described method based on contrastive learning for assisting a recommendation system to defend against shilling attacks. The system includes:
a matrix establishment module used to establish a user-item interaction matrix based on an open-source online recommendation system dataset containing fake users, and generate user feature vectors by passing user and item nodes through an embedding layer;
a data augmentation module used to perform data augmentation by sampling positive and negative samples based on the user-item interaction matrix, resulting in augmented data;
a first model establishment module used to establish a contrastive learning model based on a weighted dot product and binary cross-entropy by training with the augmented data;
a second model establishment module used to establish a user detection model based on a three-layer neural network and a focal loss function by performing model training with the user feature vectors, so as to obtain user confidence values;
a third model establishment module used to establish a recommendation model resistant to shilling attacks based on a weighted three-layer graph neural network and a Bayesian personalized ranking loss function by obtaining positive and negative sample pair data from the user-item interaction matrix and using the data, together with the user confidence values, as input data for model training; and
an auxiliary module used to perform joint training on the contrastive learning model, the user detection model and the recommendation model resistant to shilling attacks, perform dot product operations between each user's feature vector and all items' feature vectors to obtain scores, and generate a recommendation list for the user.

The present disclosure discloses the following technical effects.

The present disclosure addresses the issues of low accuracy in detecting fake users and poor recommendation effectiveness under shilling attacks, and effectively improves the accuracy of detecting fake users and the defense capability of the recommendation system against shilling attacks.

### BRIEF DESCRIPTION OF DRAWINGS

To illustrate embodiments of the present disclosure or technical solutions in the prior art more clearly, an accompanying drawing required for use in the embodiments will be briefly introduced in the following. Obviously, the drawing described below is only intended to illustrate some embodiments of the present disclosure. For those of ordinary skill in the art, other drawings can be obtained based on the drawing without paying creative effort.

The single drawing is a logic framework diagram of a method described in the present disclosure.

### DETAILED DESCRIPTION OF THE EMBODIMENTS

To make the purpose, technical solutions and advantages of the embodiments of the present application clearer, the technical solutions in the embodiments of the present application will be clearly and completely described below in conjunction with the drawing for the embodiments. Obviously, the described embodiments are only some, not all, of the embodiments of the present application. The components in the embodiments of the present application, as generally described and illustrated in the drawing herein, may be arranged and designed in a wide variety of different configurations. Therefore, the following detailed description of the embodiments of the present application provided in the drawing is not intended to limit the scope claimed by the present application, but is merely representative of selected embodiments of the present application. Based on those embodiments of the present application, all other embodiments obtained by those of ordinary skill in the art without paying any creative effort shall fall within the protection scope of the present application.

As shown in the drawing, a method based on contrastive learning for improving defense against shilling attacks in a recommendation system, as disclosed in the present disclosure, specifically includes the following aspects.
1. An interaction matrix is established using interaction data, neighbor nodes of the target user are taken as positive samples, and neighbor nodes of a non-target user are taken as negative samples, thereby achieving data augmentation.
2. Feature vectors are generated by passing all users and items through an embedding layer, and a contrastive learning model is established using a weighted dot product and a binary cross-entropy loss function, with the augmented data serving as the input data for this model.
3. A user detection model is established using a three-layer neural network and a focal loss function. The user feature vectors are taken as the input data for this model to obtain user confidence values. Item confidence values are obtained by performing graph convolution operations on the interaction matrix with the user confidence values.
4. A recommendation model is established using a three-layer graph neural network, a pooling operation and a Bayesian personalized ranking loss function. The confidence values are used as the weights for the graph neural network's convolution operations, and the user feature vectors and the item feature vectors are used as the input data for this model.
5. The three models are jointly trained. After training, user-item interaction scores are computed, and the top-20 scoring interacted items are taken to form the user's recommendation list.

As mentioned in the present disclosure, the method based on contrastive learning for improving defense against shilling attacks in a recommendation system specifically includes the following steps:
Step S1: establishing a user-item interaction matrix, and generating feature vectors for user and item nodes through an embedding layer;
Step S2: achieving data augmentation by sampling positive and negative samples, and obtaining a positive sample feature vector set and a negative sample feature vector set;
Step S3: establishing a contrastive learning model using a weighted dot product and a binary cross-entropy loss function, and training the contrastive learning model using the augmented data to enlarge the difference between the feature vectors of fake users and normal users;
Step S4, establishing a user detection model using a three-layer neural network and a focal loss function, and training this model by using the user feature vectors as input data, thereby obtaining user confidence values;
Step S5, establishing recommendation model resistant to shilling attacks using a weighted three-layer graph neural network and a Bayesian personalized ranking loss function, performing Bayesian positive-negative pair sampling on the interaction matrix, and training this model by using the positive-negative sample pair data and the user confidence values as input data; and
Step S6: performing joint training on the contrastive learning model, the user detection model, and the recommendation model resistant to shilling attacks, obtaining, after the training, scores by calculating the dot product of each user's feature vector and the feature vectors of all items, and taking the top-20 scoring ones from the items, with which the user has interacted, as the user's recommendation list.

Detailed description is as follows. S1. Establishment of a User-item Interaction Matrix:

Given a user set U and an item set I, edges are established based on whether an interaction exists between user u and item i.

$$Edge ( u , i ) = \{ \begin{matrix}1 , & if there is an interaction between user u and item i \\ 0 , & if there is no interaction between user u and item i\end{matrix} ;$$

a user feature matrix Eᵤ and an item feature matrix Eᵢ are generated for all users and items, where the feature vector of user u is eᵤ and the feature vector of item i is eᵢ.

### S2. Data Augmentation:

Each user is taken as a target user, and a positive sample subgraph feature vector set is obtained by performing proportional sampling from the set of items with which the target user has interacted. An arbitrary non-target user node is selected, and a negative sample subgraph feature vector set is obtained by performing proportional sampling from the set of items with which this non-target user has interacted.

### S3. Establishment of a Contrastive Learning Model:

The positive and negative sample subgraph feature vector sets are stacked and undergo an average pooling operation separately to obtain the subgraph feature vectors. The calculation is as follows:

$${e}_{j} = mean ( concat ( {e}_{j 1} , {e}_{j 2} , … ) ) ;$$

where eⱼ represents the subgraph feature vector, eⱼᵢ represents the feature vector of the i-th item in the subgraph feature vector set, concat denotes the concatenation operation, and mean denotes the averaging operation. The subgraph feature vectors then respectively undergo a weighted dot product operation with the target user's feature vector to obtain scores:

$${s}_{i} = σ ( {e}_{u} W {e}_{j}^{T} ) ;$$

where eᵤ represents the target user's feature vector, eⱼ represents the feature vector of either the positive sample subgraph or the negative sample subgraph, and Sᵢ represents the score. The binary cross-entropy (BCE) loss function is used for learning and training of the contrastive model, where the label for the positive subgraph feature vector is 1 and label for the negative subgraph feature vector is 0. The calculation is as follows:

$${L}_{BCELoss} = - \frac{1}{N} {\sum }_{i = 1}^{N} [ {l}_{i} log ( {s}_{i} ) + ( 1 - {l}_{i} ) log ( 1 - {s}_{i} ) ] ;$$

where s is the subgraph score, and l represents the label of the subgraph.

### S4. Establishment of a User Detection Model:

The user features are used as input and passed through a three-layer neural network to perform feature extraction and obtain a classification score:

$${p}_{u} = σ ( {e}_{u} W ) ;$$

where eᵤ is the user feature vector, W is the weight matrix, σ denotes the activation function with ReLu applied to the first two layers and sigmoid to the last layer, and pᵤ represents the confidence value of user u. At the same time, the focal loss function is computed to train the user detection model. The calculation is as follows:

$${L}_{FocalLoss} = - {{α}_{t} ( 1 - {p}_{u} )}^{γ} log ( {p}_{u} ) ;$$

where aₜ and γ represent weights.

### S5. Establishment of a Recommendation Model Resistant to Shilling Attacks:

Sampling is performed on the interaction matrix from S1 to obtain positive and negative sample pairs (u, i₊, j₋), where i₊ denotes an item i that the user u has interacted with, and j₋ denotes an item j that the user u has not interacted with.

Convolution operations are performed on the graph using user confidence values to compute item confidence values. The calculation is as follows:

$${p}_{v} = \frac{1}{\vert {N}_{v} \vert} {\sum }_{u ∈ {N}_{v}} {p}_{u} ;$$

where |Nᵥ| represents the number of neighbors of the item node, pᵤ denotes the user confidence value, and pᵥ denotes the item confidence value. The confidence values are used as weights in the convolution operation to compute the feature vectors of item nodes after convolution.

$${e}_{u}^{( 0 )} and {e}_{v}^{( 0 )}$$

are fetched from the Eᵤ and Eᵥ matrices respectively. The calculation is as follows:

$${e}_{v}^{( k + 1 )} = {\sum }_{u ∈ {N}_{v}} \frac{{p}_{u}}{\sqrt{\vert {N}_{v} \vert} \sqrt{\vert {N}_{u} \vert}} {e}_{u}^{( k )} ;$$

where pᵤ denotes the user confidence value,

$${e}_{v}^{( k + 1 )}$$

is the feature vector of item node v at the (k+1)th layer,

$${e}_{u}^{( k )}$$

is the feature vector of user node u at the k-th layer, |Nᵥ| represents the number of neighbors of the item node, |Nᵤ| represents the number of neighbors of the user node. Similarly, the feature vector of the user node after convolution is computed:

$${e}_{u}^{( k + 1 )} = {\sum }_{u ∈ {N}_{u}} \frac{{p}_{v}}{\sqrt{\vert {N}_{u} \vert} \sqrt{\vert {N}_{v} \vert}} {e}_{v}^{( k )} ;$$

where pᵥ denotes the item confidence value. After three graph convolutional layers, feature vectors from the three layers are obtained, and an average pooling operation is applied:

$${e}_{u}^{′} = mean ( {e}_{u}^{( 0 )} , {e}_{u}^{( 1 )} , {e}_{u}^{( 2 )} , {e}_{u}^{( 3 )} ) .$$

The item feature vectors are computed similarly. The feature vector for each node is obtained, and the model is trained using the positive and negative sample pairs (u, i, j) combined with the Bayesian personalized ranking loss function L_{BPR}:

$${L}_{BPR} = - {\sum }_{( u , i , j ) ∈ D} ln σ ( - ) .$$

### S6. Joint Training:

The loss functions of the contrastive learning model, the user detection model, and the recommendation model resistant to shilling attacks are combined for joint training:

$$L = {L}_{BPR} + α {L}_{BCELoss} + β {L}_{FocalLoss} ;$$

after training is completed, the dot product between each user's feature vector and the feature vectors of all items is computed to obtain scores. The top-20 scoring ones from the items with which the user has interacted are taken as the user's recommendation list:

$${s}_{i} = {e}_{u} {e}_{j}^{T} ;$$

where eᵤ denotes the feature vector of user u, and eⱼ denotes the feature vector of item j.

Based on the recommendation system, the present disclosure combines contrastive learning and a multi-layer perceptron to detect fake users and utilizes confidence values as weights to implement a recommendation system method resistant to shilling attacks. This technology addresses the issues of low accuracy in detecting fake users and poor recommendation performance under shilling attacks, effectively improving the accuracy of detecting fake users and the capability of the recommendation system to defend against shilling attacks.

The present disclosure has been described with reference to the flowchart and/or block diagram of the methods, apparatuses (systems), and computer program products according to embodiments of the present disclosure. It should be understood that each process and/or block in the flowchart and/or block diagram, and combinations of the processes and/or blocks in the flowchart and/or block diagram, can be implemented by computer program instructions. These computer program instructions can be provided to a processor of a general-purpose computer, special-purpose computer, embedded processing machine, or other programmable data processing apparatus to produce a machine, such that the instructions executed by the processor of the computer or other programmable data processing apparatus create means for implementing the functions specified in one or more processes in the flowchart and/or one or more blocks in the block diagram.

In the description of the present disclosure, it should be understood that the terms “first” and “second” are used for descriptive purposes only and cannot be construed as indicating or implying relative importance or implicitly specifying the quantity of the technical features referred to. Therefore, features defined with “first” or “second” may explicitly or implicitly include one or more such features. In the description of the present disclosure, the term “a plurality of” means two or more, unless expressly and specifically specified otherwise.

Obviously, those of ordinary skill in the art can make various changes and modifications to the present disclosure without departing from the spirit and scope of the present disclosure. Thus, provided that such modifications and variations of the present disclosure fall within the scope of the claims of the present disclosure and their equivalents, the present disclosure is intended to encompass these modifications and variations.

What is claimed is:

1. A method based on contrastive learning for assisting a recommendation system to defend against shilling attacks, the method comprising the following steps:
based on an open-source online recommendation system dataset containing fake users, establishing a user-item interaction matrix, and generating user feature vectors by passing user and item nodes through an embedding layer;
based on the user-item interaction matrix, performing data augmentation by sampling positive and negative samples, resulting in augmented data;
based on a weighted dot product and binary cross-entropy, establishing a contrastive learning model by training with the augmented data;
based on a three-layer neural network and a focal loss function, establishing a user detection model by performing model training with the user feature vectors, thereby obtaining user confidence values,
wherein user features are used as input and passed through the three-layer neural network to perform feature extraction and obtain a classification score:
$${p}_{u} = σ ( {e}_{u} W ) :$$
wherein eᵤ is a user feature vector, W is a weight matrix, σ denotes an activation function with ReLu applied to the first two layers and sigmoid to the last layer, and pᵤ represents the user confidence value of user u;
based on a weighted three-layer graph neural network and a Bayesian personalized ranking loss function, obtaining positive and negative sample pair data by using the user-item interaction matrix, and using the data together with the user confidence values as input data for model training, thereby establishing a recommendation model resistant to shilling attacks,
wherein, in the process of establishing the recommendation model resistant to shilling attacks, the confidence values are used as weights in convolution operations with the confidence values comprising user confidence values and item confidence values, and the item confidence values are obtained by performing graph convolution operations on the interaction matrix using the user confidence values; and
performing joint training on the contrastive learning model, the user detection model, and the recommendation model resistant to shilling attacks, performing dot product operations between each user's feature vector and all items' feature vectors to obtain scores, and generating a recommendation list for the user.

2. The method based on contrastive learning for assisting a recommendation system to defend against shilling attacks of claim 1, wherein:
in the process of performing data augmentation, each user is taken as a target user, and a positive sample subgraph feature vector set is obtained by performing proportional sampling from the set of items with which the target user has interacted; an arbitrary non-target user node is selected, and a negative sample subgraph feature vector set is obtained by performing proportional sampling from the set of items with which the non-target user has interacted; the augmented data is generated based on the positive sample subgraph feature vector set and the negative sample subgraph feature vector set.

3. The method based on contrastive learning for assisting a recommendation system to defend against shilling attacks of claim 2, wherein:
in the process of establishing the contrastive learning model, the positive and negative sample subgraph feature vector sets are stacked and undergo an average pooling operation separately, to obtain the subgraph feature vectors;
the subgraph feature vectors then respectively undergo a weighted dot product operation with the target user's feature vector to obtain scores; and
a binary cross-entropy (BCE) loss function is used for learning and training to establish the contrastive learning model.

4. The method based on contrastive learning for assisting a recommendation system to defend against shilling attacks of claim 3, wherein:
in the process of establishing the user detection model, ReLu is applied to the first two layers of the three-layer neural network, and sigmoid is applied to the last layer.

5. The method based on contrastive learning for assisting a recommendation system to defend against shilling attacks of claim 4, wherein:
in the process of sampling negative sample pairs, Bayesian positive and negative sample pair sampling is performed on the user-item interaction matrix.

6. The method based on contrastive learning for assisting a recommendation system to defend against shilling attacks of claim 1, wherein:
in the process of generating the recommendation list, the top-20 scoring ones from the items with which the user has interacted are taken as the user's recommendation list.

7. A system based on contrastive learning for assisting a recommendation system to defend against shilling attacks, the system being used to implement the method based on contrastive learning for assisting a recommendation system to defend against shilling attacks of claim 1, and comprising:
a matrix establishment module used to establish a user-item interaction matrix based on an open-source online recommendation system dataset containing fake users, and generate user feature vectors by passing user and item nodes through an embedding layer;
a data augmentation module used to perform data augmentation by sampling positive and negative samples based on the user-item interaction matrix, resulting in augmented data;
a first model establishment module used to establish a contrastive learning model based on a weighted dot product and binary cross-entropy by training with the augmented data;
a second model establishment module used to establish a user detection model based on a three-layer neural network and a focal loss function by performing model training with the user feature vectors, so as to obtain user confidence values;
a third model establishment module used to establish a recommendation model resistant to shilling attacks based on a weighted three-layer graph neural network and a Bayesian personalized ranking loss function by obtaining positive and negative sample pair data from the user-item interaction matrix and using the data, together with the user confidence values, as input data for model training; and
an auxiliary module used to perform joint training on the contrastive learning model, the user detection model and the recommendation model resistant to shilling attacks, perform dot product operations between each user's feature vector and all items' feature vectors to obtain scores, and generate a recommendation list for the user.
